(19) United States
(12) Patent Application Publication
(10) Pub. No.: US 2010/0265904 A1
(43) Pub. Date: Oct. 21, 2010

(54) METHOD, APPARATUS AND COMPUTER PROGRAM PRODUCT FOR INTERFERENCE AVOIDANCE IN UPLINK COORDINATED MULTI-POINT RECEPTION

(75) Inventors: Hua-Lung Yang, Taipei City (TW); Ren-Jr Chen, Hsinchu City (TW); Ming-Bing Chen, Taipei City (TW); Chien-Min Lee, Xinzhuang City (TW); Hao-Wen Chen, Taipei City (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Industrial Technology Research Institute

(21) Appl. No.: 12/762,731

(22) Filed: Apr. 19, 2010

Related U.S. Application Data
(60) Provisional application No. 61/171,225, filed on Apr. 21, 2009.
(60) Provisional application No. 61/176,228, filed on May 7, 2009.
(60) Provisional application No. 61/237,773, filed on Aug. 28, 2009.

(51) Int. Cl. H04W 72/04; H04L 27/28

(52) U.S. Cl. 370/329; 375/260

(57) ABSTRACT

A method of providing interference avoidance in uplink CoMP may include generating an orthogonal frequency division multiplexing (OFDM) symbol for uplink transmission to coordinated multi-point (CoMP) cells, and providing a cyclic-prefix and a cyclic-postfix for the OFDM symbol generated to reduce uplink interference without backhaul transmission for delay or timing advance information. A corresponding apparatus and computer program product are also provided. An alternative method of providing interference avoidance in uplink CoMP may include measuring timing differences between downlink signals received at a mobile terminal in connection with coordinated multi-point (CoMP) transmission from a serving cell and one or more coordinating cells and adjusting uplink transmission timing for signals to be transmitted from the mobile terminal based on the timing differences measured. A corresponding apparatus and computer program product are also provided.

### CROSS REFERENCE TO RELATED APPLICATION

This application claims the benefit of U.S. Provisional Application No. 61/171,225, filed Apr. 21, 2009, U.S. Provisional Application No. 61/176,228, filed May 7, 2009, and U.S. Provisional Application No. 61/237,773, filed Aug. 28, 2009, the contents of each of which are incorporated herein in their entirety.

### TECHNOLOGICAL FIELD

Embodiments of the present invention relate generally to communication technology and, more particularly, relate to an apparatus, method and a computer program product for providing interference avoidance in uplink coordinated multi-point (CoMP) reception.

### BACKGROUND

In order to provide easier or faster information transfer and convenience, telecommunication industry service providers are continually developing improvements to existing networks. For example, the evolved universal mobile telecommunications system (UMTS) terrestrial radio access networks (UTRAN and E-UTRAN), the GERAN (GSM/EDGE) system and the like are being developed along with advancements related to Worldwide Interoperability for Microwave Access (WiMAX), Wireless Municipal Access Network (WirelessMAN) and other technologies.

Coordinated multi-point (CoMP) transmission/reception has been considered by some to be an essential technology for improvement in the ability to provide coverage with high data rates for LTE-advanced. CoMP is also expected to improve cell-edge throughput and/or to increase overall system throughput. For example, for a mobile terminal or user equipment (UE) positioned at a cell-edge, throughput could be improved by coordination among many cell-sites in an active CoMP set, where the cell-sites could communicate with each other by data/channel state information (CSI) via backhauling transmission. However, one main drawback of backhauling transmission is that it can be time-consuming, and therefore the data/CSI may be out-of-date by the time it is received. In an uplink (UL) CoMP scenario, a UE's signal to different cell-sites may experience different delay spreads, and the signal may arrive at one CoMP cell-site in advance of the arrival of the signal at another CoMP cell-site, where the timing among different cell-sites has been synchronized. This time delay issue can potentially degrade the performance of CoMP, especially in heterogeneous cells.

Accordingly, it may be desirable to provide an improved mechanism for interference avoidance in CoMP.

### BRIEF SUMMARY

A method, apparatus and computer program product are therefore provided that may enable the provision interference avoidance in CoMP reception. Some embodiments may jointly use a cyclic-postfix in orthogonal frequency division multiplexing (OFDM) symbols for addressing timing-advance issues, and a cyclic-prefix for addressing timing-delay issues. By doing so, a need for sharing delay information via backhaul may be removed and CoMP performance may still be maintained. In some alternative embodiments, timing differences may be measured between downlink transmissions of serving and coordinating cells to provide uplink timing adjustments.

In an exemplary embodiment, a method of providing interference avoidance in uplink CoMP is provided. The method may include generating an orthogonal frequency division multiplexing (OFDM) symbol for uplink transmission to coordinated multi-point (CoMP) cells, and providing a cyclic-prefix and a cyclic-postfix for the OFDM symbol generated to reduce uplink interference without backhaul transmission for delay or timing advance information.

In another exemplary embodiment, an apparatus for providing interference avoidance in uplink CoMP is provided. The apparatus may include a processor. The processor may be configured to generate an orthogonal frequency division multiplexing (OFDM) symbol for uplink transmission to coordinated multi-point (CoMP) cells, and provide a cyclic-prefix and a cyclic-postfix for the OFDM symbol generated to reduce uplink interference without backhaul transmission for delay or timing advance information.

In an exemplary embodiment, a computer program product for providing interference avoidance in uplink CoMP is provided. The computer program product may include at least one computer-readable storage medium having computer-executable program code instructions stored therein. The computer-executable program code instructions may include program code instructions for generating an orthogonal frequency division multiplexing (OFDM) symbol for uplink transmission to coordinated multi-point (CoMP) cells, and providing a cyclic-prefix and a cyclic-postfix for the OFDM symbol generated to reduce uplink interference without backhaul transmission for delay or timing advance information.

In another exemplary embodiment, another method of providing interference avoidance in uplink CoMP is provided. The method may include measuring timing differences between downlink signals received at a mobile terminal in connection with coordinated multi-point (CoMP) transmission from a serving cell and one or more coordinating cells and adjusting uplink transmission timing for signals to be transmitted from the mobile terminal based on the timing differences measured.

In another exemplary embodiment, another apparatus for providing interference avoidance in uplink CoMP is provided. The apparatus may include a processor. The processor may be configured to measure timing differences between downlink signals received at a mobile terminal in connection with coordinated multi-point (CoMP) transmission from a serving cell and one or more coordinating cells and adjust uplink transmission timing for signals to be transmitted from the mobile terminal based on the timing differences measured.

In an exemplary embodiment, another computer program product for providing interference avoidance in uplink CoMP is provided. The computer program product may include at least one computer-readable storage medium having computer-executable program code instructions stored therein. The computer-executable program code instructions may include program code instructions for measuring timing differences between downlink signals received at a mobile terminal in connection with coordinated multi-point (CoMP) transmission from a serving cell and one or more coordinating cells and adjusting uplink transmission timing for signals to be transmitted from the mobile terminal based on the timing differences measured.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates an example cell configuration in which CoMP may be employed according to an exemplary embodiment of the present invention;

FIG. 2 illustrates examples of potential interference causing time delays/advances that may be encountered in connection with CoMP according to an exemplary embodiment of the present invention;

FIG. 3 illustrates a diagram of the timing that may be associated with interference caused by time delay/advance;

FIG. 4 illustrates an example cell configuration that may be employed involving a femto or pico cell within a macro cell according to an exemplary embodiment of the present invention;

FIG. 5 illustrates the structure of an OFDM signal constructed to include both a cyclic-prefix and cyclic-postfix according to an exemplary embodiment of the present invention;

FIG. 6 illustrates a diagram of the timing that may be associated with preventing interference caused by time delay/advance by using both the cyclic-prefix and cyclic-postfix according to an exemplary embodiment of the present invention;

FIG. 7 illustrates a CoMP scenario with a serving cell and coordinating cells capable of communication with a user equipment (UE) according to an exemplary embodiment of the present invention;

FIG. 8 illustrates the propagation delays that may be experienced for downlink transmissions from the geographically separated cells shown in FIG. 7 according to an exemplary embodiment of the present invention;

FIG. 9 is a block diagram of an apparatus for providing interference avoidance in UL CoMP according to an exemplary embodiment of the present invention;

FIG. 10 is a flowchart according to an exemplary method for providing interference avoidance in UL CoMP reception according to an exemplary embodiment of the present invention; and

FIG. 11 is a flowchart according to another exemplary method for providing interference avoidance in UL CoMP reception according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. Moreover, it should be noted that while some example embodiments may relate to inter-eNB cases, as shown below, alternative embodiments may also be practiced in the context of intra-eNB cases (e.g., where coordinated multiple cells belong to one identical eNB).

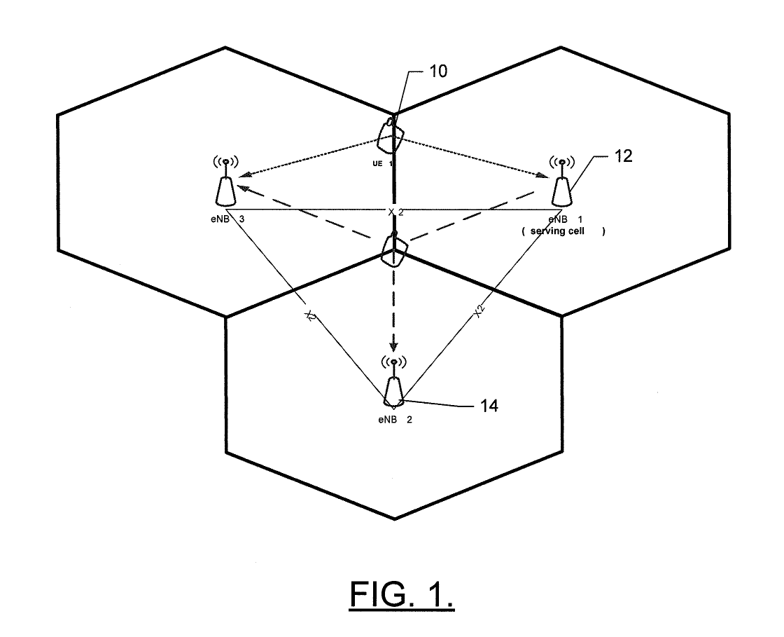

When a UE is supported for uplink CoMP transmission, as shown in FIG. 1, the UE may transmit uplink data through a physical uplink shared channel (PUSCH), or transmit an uplink control signal through a physical uplink control channel (PUCCH), to the active CoMP cell-sites or eNBs (evolved node-Bs). In a typical CoMP scenario, a UE has a serving cell that transmits signals to the UE over a PDCCH (physical downlink control channel). In a UL CoMP scenario, as shown in FIG. 1, a UE at a cell edge (e.g., UE 10) may transmit PUSCH/PUCCH to a first eNB (e.g., serving cell, eNB 12) and one or more other eNBs (e.g., eNB 14). Then, eNB 12 and eNB 14 may process joint detection through backhauling to improve the detection performance.

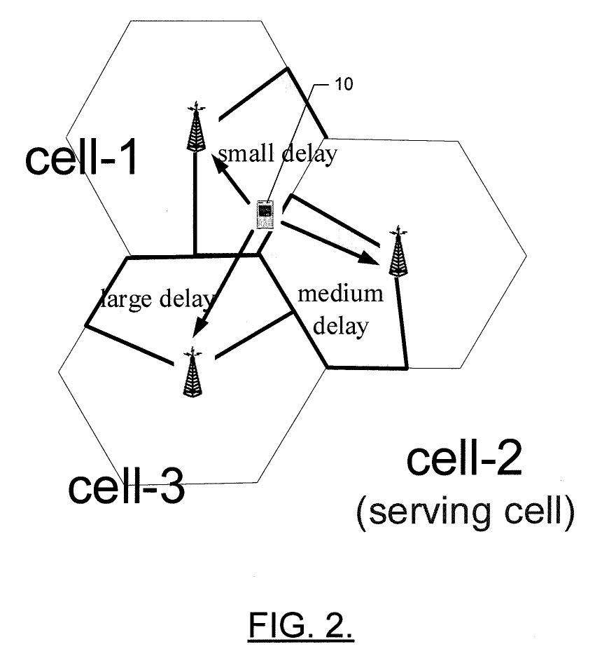

In the UL CoMP scenario, a UE's UL signal may arrive at different cell-sites at different times due to differing path lengths or other factors. In other words, the UE's UL signal may be time dispersive due to delay spreads. FIG. 2 illustrates the potential for different delays according to an example embodiment. In this regard, UE 10 is shown in FIG. 2 as being near an intersection between three cells (e.g., cell-1, cell-2 and cell-3). Although cell-2 is the serving cell, the UE 10 is actually physically closest to the eNB associated with cell-1. Thus, the eNB associated with cell-2 can be expected to experience a medium delay as compared to the eNB associated with cell-1 (which will experience a relatively short delay), and the eNB associated with cell-3 (which will experience a relatively long delay). Since cell-2 is the serving cell, the eNB associated with cell-2 may be assumed to be the only eNB that can provide a timing advance command to the UE 10 via PDCCH. Thus, transmission timing provided by the eNB associated with cell-2 may be adjusted such that the received signal falls into the interval of a cyclic-prefix.

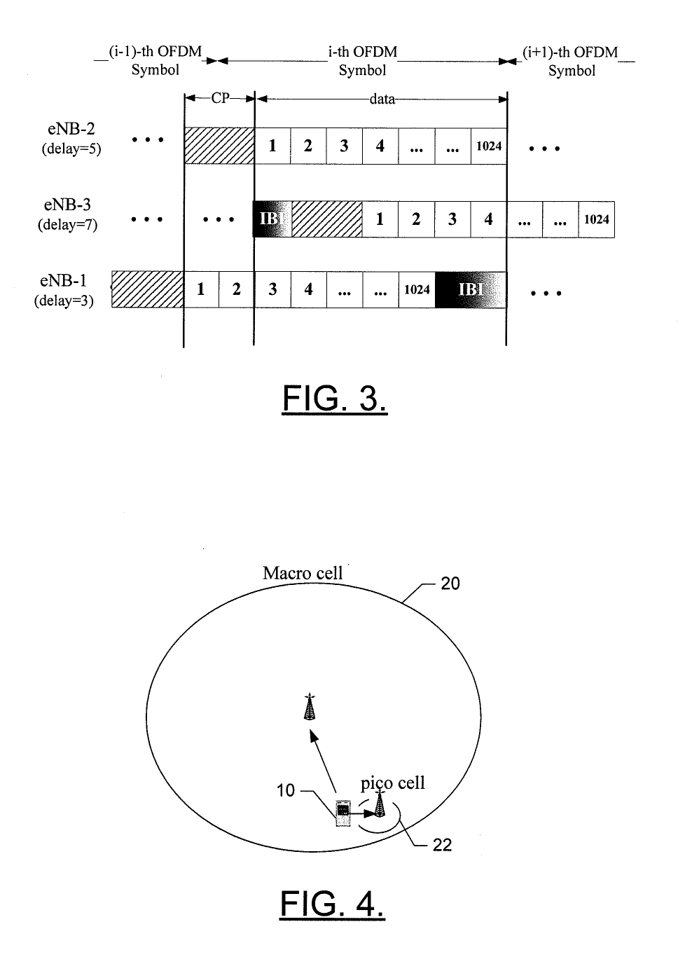

Considering the delay spreads that are illustrated in FIG. 2, and that the timing among eNBs is assumed to be synchronized, FIG. 3 shows an example of the received signals that could be experienced by the eNBs of FIG. 2 in which eNB-1 is the eNB associated with cell-1, eNB-2 is eNB associated with cell-2 and eNB-3 is the eNB associated with cell-3. As can be appreciated from FIG. 3, the transmission time of UE 10 may be adjusted according to the eNB timing illustrated in FIG. 3 (e.g., using a cyclic-prefix (CP)). However, the delay spread to eNB-1 is less, so the signal at eNB-1 would advance the eNB timing. Similarly, the signal at eNB-3 will be delayed with respect to the eNB symbol timing. In these cases, inter-block interference (IBI) occurs at eNB-1 and eNB-3. The corresponding detection performance may therefore be reduced, and the benefits of CoMP may therefore be limited.

In a practical and extreme scenario, macro and/or pico cells may be configured to an active CoMP set to serve UEs near the cell edge. FIG. 4 illustrates an example case in which the UE 10 is located near the edge of a macro cell 20, and also near the edge of a pico cell 22. In a case such as this, when the UE's serving cell (or eNB) is the pico-cell 22, the signal at eNB of the macro cell 20 may experience a relatively large delay. By contrast, when the serving cell is the macro cell 20, the signal at eNB of the pico cell 22 may experience a relatively large advance. For either case, poor CoMP performance may result.

To address some of the issues described above, some embodiments of the present invention may add a cyclic-postfix to the end of an OFDM symbol to deal with signal advance issues. As such, for example, the cyclic-prefix may address signal delay issues, and the cyclic-postfix may address signal advance issues. By employing both the cyclic-prefix and the cyclic-postfix at the same time, no backhauling transmission for delay information may be needed. Accordingly, since backhauling transmission is time-consuming, and the latency is potentially large, the derived timing-advance information may be somewhat out-of-date and not suitable for use by the UE 10 anyway. Some examples of problems may arise in association with backhauling delay information include the fact that: 1) the delay estimation at each eNB may have to be corrected; 2) the sharing of information via backhauling may have a large latency; and 3) after deriving coordinated information from backhaul joint processing, the information may only be useful if the channel or UE is unchanged or static.

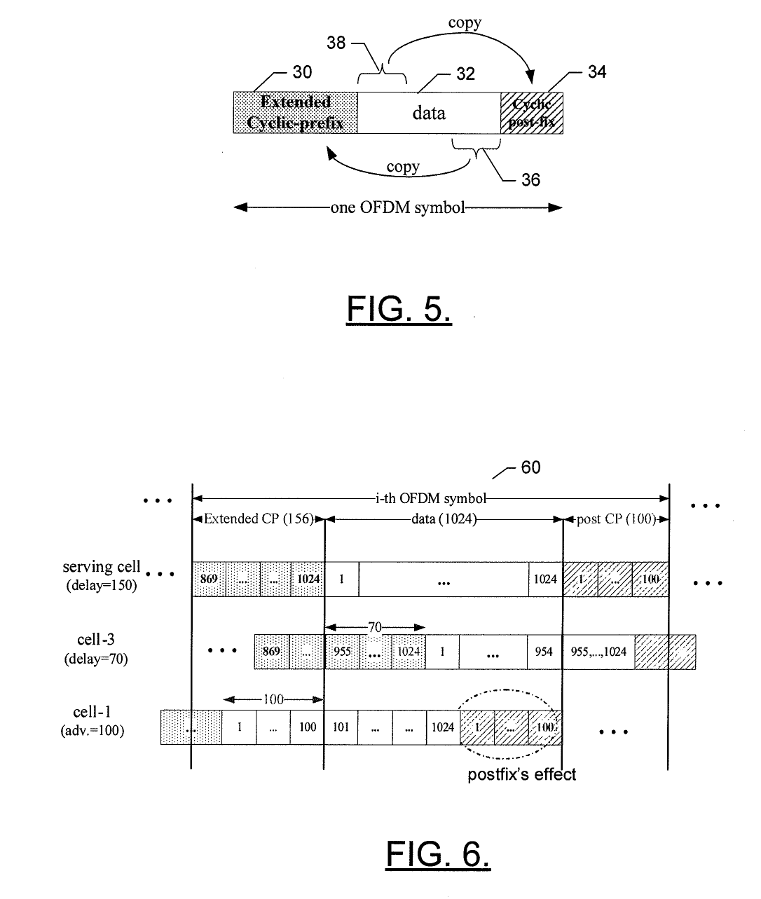

Some embodiments of the present invention may avoid or otherwise mitigate the effects of interference. In this regard, for example, a cyclic-prefix may be applied for dealing with signal delays, and a cyclic-postfix may be applied for dealing with advance issues, while avoiding the need for delay information backhauling transmissions. FIG. 5 illustrates an example of an OFDM symbol according to an exemplary embodiment in which both the cyclic-prefix and the cyclic-postfix are employed. As shown in FIG. 5, a cyclic-prefix 30 may be positioned prior to data 32 of the OFDM symbol, and a cyclic-postfix 34 may be positioned after the data 32. The cyclic-prefix 30 (which may be an extended cyclic-prefix) may include a back portion 36 of the data 32, and the cyclic-postfix 34 may include a front portion 38 of the data 32. Based on the aforementioned concepts, interference in UL CoMP due to delay spreads may be avoided while also preventing backhauling processing on the TA information and maintaining the performance/throughput gain on CoMP.

FIG. 6 shows an example of the received UL signals at each cell (e.g., Cell-1, Cell-2 and Cell-3) of the example of FIG. 2, when the cyclic-prefix 30 and the cyclic-postfix 34 are employed. In this example, the data may be 1024 samples long and the cyclic-prefix 30 may include 156 samples while the cyclic-postfix 34 may include 100 samples. Cell-3 may experience a delay of 70 samples relative to the service cell (Cell-2), but the cyclic-prefix 30 may account for the delay. Cell-1 may include an advance of 100 samples relative to the service cell, but the cyclic-postfix 34 may account for the advance. Accordingly, signals may be demodulated at each respective eNB without IBI.

In an example embodiment, the length of the cyclic-prefix 30 and the cyclic-postfix 34 may be predetermined according to cell-deployment characteristics. Moreover, the lengths of the cyclic-prefix 30 and the cyclic-postfix 34 may be different. However, in some embodiments, the lengths of the cyclic-prefix and the cyclic-postfix may be chosen such that their sum is fixed to a constant value based on system bandwidth configuration. Additionally, to avoid relatively high overhead, only some specific subframes (e.g., an MBSFN subframe) may use the proposed symbol structure described herein. Accordingly, delay and advance problems may be dealt with simultaneously, while eliminating any requirement for sharing delay spread information via the backhaul.

Although the example embodiments described above may provide a mechanism for reducing interference for UL CoMP, other alternative mechanisms for dealing with interference for UL CoMP may also exist. Some of these alternative mechanisms may be employed in addition to or instead of the example embodiments described above. For example, in some embodiments, the UE 10 may be configured to measure the timing difference between downlink transmissions received from serving and coordinating cells. The measured timing difference may then be used for UL timing adjustments.

In a wireless OFDM system, each eNB may be assumed to broadcast the synchronization channel or other downlink control signals at the same time. Each cell is differentiated from other cells by using a corresponding cell-specific physical cell identity (PCI). Accordingly, even though various eNBs may be physically separated (as shown in FIG. 2), it is reasonable to assume the synchronization channel or other downlink control signals originated at about the same time.

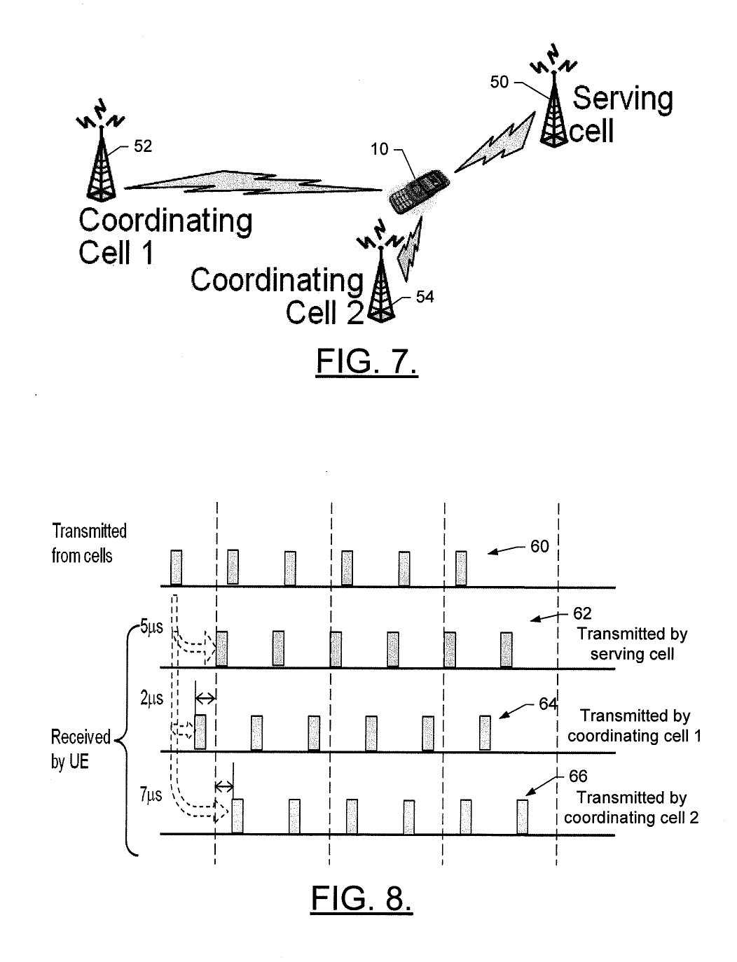

FIG. 7 illustrates an example of a system in which measurement of timing differences as described above may be useful. As shown in FIG. 7, the UE 10 may be capable of communication with a serving cell 50, a first coordinating cell 52 (cell 1) and a second coordinating cell 54 (cell 2). FIG. 8 illustrates an example of the downlink transmissions the UE 10 may receive from various geographically separated cells. Since the distances between the UE 10 and each of the serving cell 50 (e.g., corresponding to the eNB associated with Cell-2 in FIG. 2) and the first and second coordinating cells 52 and 54 (e.g., corresponding to the eNBs associated with Cell-1 and Cell-3, respectively, in FIG. 2) are different, the downlink transmissions from each of the cells may arrive at the UE 10 at corresponding different times. Thus, to acquire information indicative of the timing difference between the serving cell and other coordinating cells, the UE 10 only needs to know the difference in the arrival times of the downlink transmissions received from each of the different cells. In FIG. 8, the transmission of signals from the cells to the UE 10 is shown at timeline 60. Timelines 62, 64, and 66 illustrate the receiving timing of signals at the UE side. Timeline 62 illustrates the UE received signal transmitted by the serving cell; timeline 64 illustrates the UE received signal transmitted by coordinating cell 1; and timeline 66 illustrates the UE received signal transmitted by coordinating cell 2. Due to the difference in distances from the UE 10 to each of the cells, the UE 10 receives signals with different versions of timing delay. From this figure, it can be seen that the UE 10 firstly receives the signal transmitted by coordinating cell 1 (timeline 64), and the next signal received is the signal transmitted by the serving cell (timeline 62), finally the signal transmitted by coordinating cell 2 (timeline 66) is received. As can be appreciated from FIG. 8, signals in timeline 64 may be observed advanced three microseconds with respect to those in timeline 62, which represents the signal received from the serving cell. Thus, for example, to prevent “advancing” with respect to the first coordinating cell 52, the UE 10 may simply delay its transmission by three microseconds. Regarding “delaying”, we consider that timeline 66 can be a delayed version of timeline 62 and this can be easily be resolved by implementing a cyclic prefix with sufficient length.

Once each downlink transmission is received at a corresponding time, the UE 10 may differentiate each of the signals by correlating each signal to the transmitter that provided the respective signal. To accomplish correlation of received signals to corresponding cells, the UE 10 may be configured to look for a cell-specific channel, which may include information or indicia of cell identity that can be used as a basis for differentiation. In an example embodiment, using the concept described above, the synchronization channel may be used to differentiate the received downlink transmissions. After the timing differences between cells are acquired, the UE 10 may (or may not) report the timing differences to the serving cell 50. The UL transmissions to be provided from the UE 10 may then be adjusted accordingly depending on the UE's implementation or a command from the serving cell 50. However, in some cases, the serving cell 50 may also apply the reported timing differences to coordinate or schedule the downlink CoMP transmissions from other coordinating cells.

Accordingly, FIGS. 7 and 8 illustrate another example mechanism by which the need for backhaul signaling related to providing timing alignment information for CoMP transmissions may be avoided. As such, the use of both a cyclic-prefix and a cyclic-postfix may be used in some embodiments, and/or the use of downlink timing measurements for use in uplink timing adjustments may be employed. However, still other mechanisms for resolving the issues that arise when backhaul signaling is employed for providing timing alignment information for CoMP transmissions may also be implemented. For example, in some cases, power control methods may be employed. UL power control among the serving and coordinating cells may present an issue in some cases. Since the distances between the UE 10 and the serving and coordinating cells may be different, the received power at the serving and coordinating cells may not be the same for UL transmissions. Thus, the UE 10 may, in some cases, adjust the UL power in order to avoid or at least reduce the likelihood of interference with other UL transmissions in the coordinating cells. For this purpose, the serving cell 50 may use backhaul signaling to acquire a suggestion of the UE's transmit power from other coordinating cells. Feedback signaling may be piggybacked with a timing-advance message if a coordinating cell is asked by the serving cell to report. The signaling may be described in any format. Some exemplary formats may be the interference level that the coordinating cell is experiencing, the signal strength or the signal to interference ratio that the coordinating cell observes upon the UE's 10 UL transmissions, the preference of the UE's 10 transmit power and so on. Based on the acquired information, the serving cell 50 may determine and suggest an appropriate transmit power level to the UE 10. On the other hand, the serving cell 50 or the UE 10 may also choose the transmit power according to the acquired timing difference.

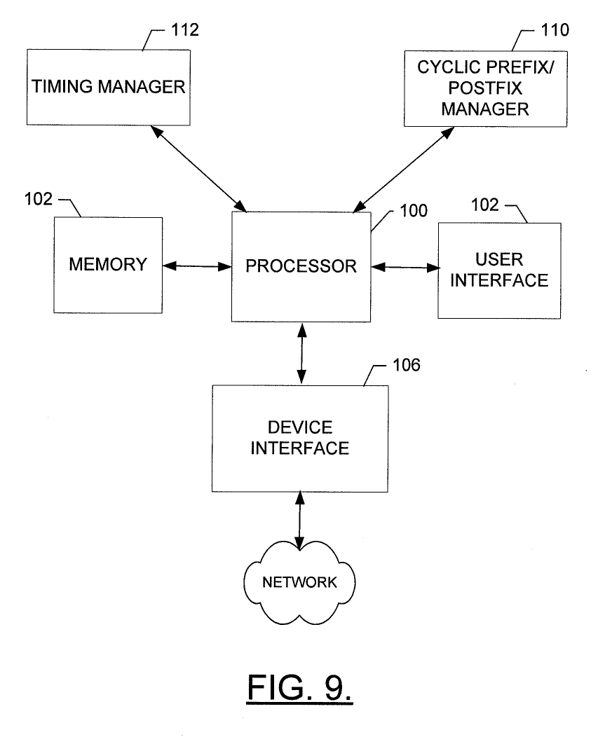

In an exemplary embodiment, an apparatus within the UE 10 (or the UE 10 itself) may be configured to perform functions associated with managing or controlling several of the operations described above. FIG. 9 illustrates an example of an apparatus for providing interference avoidance in UL CoMP. In this regard, the apparatus may include or otherwise be in communication with a processor 100, a memory 102, a user interface 104 and a device interface 106. The memory 102 may include, for example, volatile and/or non-volatile memory and may be configured to store information, data, applications, instructions or the like for enabling the apparatus to carry out various functions in accordance with exemplary embodiments of the present invention. For example, the memory 102 could be configured to buffer input data for processing by the processor 100 and/or store instructions for execution by the processor 100.

The processor 100 may be embodied in a number of different ways. For example, the processor 100 may be embodied as various processing means such as processing circuitry embodied as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 100 may be configured to execute instructions stored in the memory 102 or otherwise accessible to the processor 100. The user interface 104 may include a display, keyboard, keypad, speaker, microphone, joystick, mouse or any other mechanism for providing a human-machine interface by which data or feedback may be presented to the user and the user may provide responses or commands to the apparatus.

Meanwhile, the device interface 106 may be any means such as a device or circuitry embodied in either hardware, software, or a combination of hardware and software that is configured to receive and/or transmit data from/to a network and/or any other device or module in communication with the apparatus. In this regard, the device interface 106 may include, for example, an antenna (or multiple antennas) and supporting hardware and/or software for enabling communications with a wireless communication network. In fixed environments, the device interface 106 may alternatively or also support wired communication. As such, the device interface 106 may include a communication modem and/or other hardware/software for supporting communication via cable, digital subscriber line (DSL), universal serial bus (USB) or other mechanisms.

In an exemplary embodiment, the processor 100 may be embodied as, include or otherwise control a cyclic-prefix/postfix manager 110 and/or a timing manager 112. The cyclic-prefix/postfix manager 110 and the timing manager 112 may each be any means such as a device or circuitry embodied in hardware, software or a combination of hardware and software (e.g., processor 100 operating under software control) that is configured to perform the corresponding functions of the cyclic-prefix/postfix manager 110 and the timing manager 112, respectively, as described below.

In an exemplary embodiment, the cyclic-prefix/postfix manager 110 may be configured to apply values for both the cyclic-prefix and cyclic-postfix to selected outgoing signals transmitted by the UE 10. In some cases, the values may be predetermined, or the cyclic-prefix/postfix manager 110 may determine the values based on information descriptive of current network configuration data and predefined rules for value generation.

In an exemplary embodiment, the timing manager 112 may be configured to determine or otherwise measure DL timing for the serving cell and coordinating cells and thereafter determine an UL timing adjustment for signals to be transmitted from the UE 10 to the corresponding ones of the serving cell and the coordinating cells.

In the measure of downlink transmission, the UE 10 may directly look for any kind of transmissions from the serving and coordinating cells. The UE 10 (e.g., via the timing manager 112) may measure the arriving time of the received transmission from coordinating cells and calculate the timing difference between the serving and coordinating cells. To differentiate the downlink transmissions from cells, the UE 10 may measure transmissions corresponding to the synchronization channel, which contains the specific physical cell identity.

In an embodiment employing feedback power control information, the serving cell may acquire a suggestion of the UE's transmit power from other coordinating cells via backhaul communication. The power control information may be encapsulated in the format of interference level, the received signal strength or SINR of the UE's UL transmissions, the preference of the UE's transmit power and so on. The information may be piggybacked with a timing advance message if the serving cell is asked by the coordinating cell to report. On the other hand, the serving cell or the UE itself may determine the appropriate transmit power according the observed time advance information. Embodiments of the present invention may be applicable to 3GPP LTE/LTE-A, IEEE 802.16m and many other specifications.

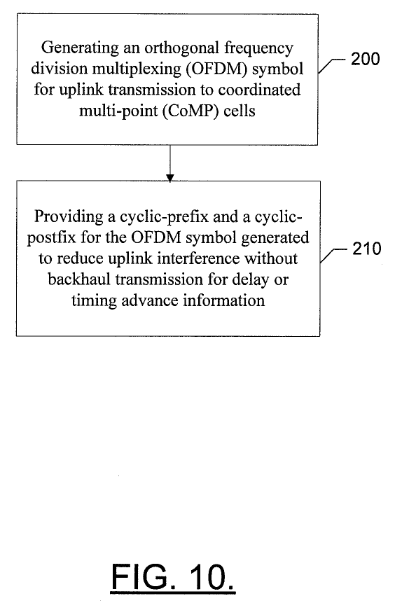

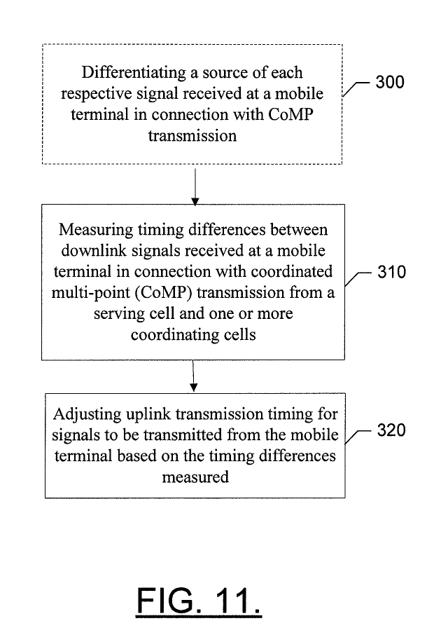

FIGS. 10 and 11 are flowcharts of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory and executed by a processor. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s). These computer program instructions may also be stored in a computer-readable electronic storage memory that can direct a computer or other programmable apparatus to function in a particular manner, such that the instructions stored in the computer-readable memory produce an article of manufacture including instruction means which implement the function specified in the flowcharts block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts block(s).

Accordingly, blocks of the flowcharts support combinations of means for performing the specified functions, combinations of operations for performing the specified functions and program instruction means for performing the specified functions. It will also be understood that one or more blocks of the flowcharts, and combinations of blocks in the flowcharts, can be implemented by special purpose hardware-based computer systems which perform the specified functions or operations, or combinations of special purpose hardware and computer instructions.

In this regard, one embodiment of a method for providing interference avoidance in UL CoMP reception as provided in FIG. 10 may include generating an orthogonal frequency division multiplexing (OFDM) symbol for uplink transmission to coordinated multi-point (CoMP) cells at operation 200, and providing a cyclic-prefix and a cyclic-postfix for the OFDM symbol generated to reduce uplink interference without backhaul transmission for delay or timing advance information at operation 210.

In some embodiments, certain ones of the operations above may be modified or further amplified as described below. It should be appreciated that each of the modifications or amplifications below may be included with the operations above either alone or in combination with any others among the features described herein. In this regard, for example, providing the cyclic-prefix and the cyclic-postfix may include providing the cyclic-prefix and the cyclic-postfix each with a respective length that is determined based on cell deployment. In some cases, providing the cyclic-prefix and the cyclic-postfix may include providing the cyclic-prefix and the cyclic-postfix such that a sum of lengths of the cyclic-prefix and the cyclic-postfix is fixed to a constant value based on system bandwidth configuration. The cyclic-prefix and the cyclic-postfix may also have the same or different lengths. In an example embodiment, providing the cyclic-prefix and the cyclic-postfix may include providing the cyclic-prefix and the cyclic-postfix to only selected subframes.

In an exemplary embodiment, an apparatus for performing the method of FIG. 10 above may comprise a processor (e.g., the processor 100) configured to perform some or each of the operations (200-210) described above. The processor may, for example, be configured to perform the operations (200-210) by performing hardware implemented logical functions, executing stored instructions, or executing algorithms for performing each of the operations.

Another example embodiment of a method for providing interference avoidance in UL CoMP reception as provided in FIG. 11 may include measuring timing differences between downlink signals received at a mobile terminal in connection with coordinated multi-point (CoMP) transmission from a serving cell and one or more coordinating cells at operation 310. The method may further include adjusting uplink transmission timing for signals to be transmitted from the mobile terminal based on the timing differences measured at operation 320.

In some embodiments, the method may include further optional operations, an example of which is shown in dashed lines in FIG. 11. Optional operations may be performed in any order and/or in combination with each other in various alternative embodiments. As such, the method may further include differentiating a source of each respective signal received at the mobile terminal in connection with CoMP transmission at operation 300.

In some embodiments, certain ones of the operations above may be modified or further amplified as described below. It should be appreciated that each of the modifications or amplifications below may be included with the operations above either alone or in combination with any others among the features described herein. In this regard, for example, differentiating the source may include measuring transmissions corresponding to a downlink channel (or signaling) associated with timing synchronization or indicative of cell identity (e.g., a synchronization channel). In some embodiments, differentiating the source may include associating a physical cell identity of each signal measured from the downlink channel with a corresponding received signal.

In an exemplary embodiment, an apparatus for performing the method of FIG. 11 above may comprise a processor (e.g., the processor 100) configured to perform some or each of the operations (300-320) described above. The processor may, for example, be configured to perform the operations (300-320) by performing hardware implemented logical functions, executing stored instructions, or executing algorithms for performing each of the operations.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
generating an orthogonal frequency division multiplexing (OFDM) symbol for uplink transmission to coordinated multi-point (CoMP) cells; and
providing a cyclic-prefix and a cyclic-postfix for the OFDM symbol generated to reduce uplink interference without backhaul transmission for delay or timing advance information.

2. The method of claim 1, wherein providing the cyclic-prefix and the cyclic-postfix comprises providing the cyclic-prefix and the cyclic-postfix each with a respective length that is determined based on cell deployment.

3. The method of claim 1, wherein providing the cyclic-prefix and the cyclic-postfix comprises providing the cyclic-prefix and the cyclic-postfix such that a sum of lengths of the cyclic-prefix and the cyclic-postfix is fixed to a constant value based on system bandwidth configuration.

4. The method of claim 1, wherein providing the cyclic-prefix and the cyclic-postfix comprises providing the cyclic-prefix and the cyclic-postfix to only selected subframes.

5. The method of claim 1, wherein providing the cyclic-prefix and the cyclic-postfix comprises providing the cyclic-prefix and the cyclic-postfix such that a length of the cyclic-prefix is enabled to be different than a length of the cyclic-postfix.

6. An apparatus comprising a processor configured to:
generate an orthogonal frequency division multiplexing (OFDM) symbol for uplink transmission to coordinated multi-point (CoMP) cells; and
provide a cyclic-prefix and a cyclic-postfix for the OFDM symbol generated to reduce uplink interference without backhaul transmission for delay or timing advance information.

7. The apparatus of claim 6, wherein the processor being configured to provide the cyclic-prefix and the cyclic-postfix comprises the processor being configured to provide the cyclic-prefix and the cyclic-postfix each with a respective length that is determined based on cell deployment.

8. The apparatus of claim 6, wherein the processor being configured to provide the cyclic-prefix and the cyclic-postfix comprises the processor being configured to provide the cyclic-prefix and the cyclic-postfix such that a sum of lengths of the cyclic-prefix and the cyclic-postfix is fixed to a constant value based on system bandwidth configuration.

9. The apparatus of claim 6, wherein the processor being configured to provide the cyclic-prefix and the cyclic-postfix comprises the processor being configured to provide the cyclic-prefix and the cyclic-postfix to only selected subframes.

10. The apparatus of claim 6, wherein the processor being configured to provide the cyclic-prefix and the cyclic-postfix comprises the processor being configured to provide the cyclic-prefix and the cyclic-postfix such that a length of the cyclic-prefix is enabled to be different than a length of the cyclic-postfix.

11. A computer program product comprising at least one computer-readable storage medium having computer-executable program code instructions stored therein, the computer-executable program code instructions comprising:
program code instructions for generating an orthogonal frequency division multiplexing (OFDM) symbol for uplink transmission to coordinated multi-point (CoMP) cells; and
program code instructions for providing a cyclic-prefix and a cyclic-postfix for the OFDM symbol generated to reduce uplink interference without backhaul transmission for delay or timing advance information.

12. The computer program product of claim 11, wherein program code instructions for providing the cyclic-prefix and the cyclic-postfix include instructions for providing the cyclic-prefix and the cyclic-postfix each with a respective length that is determined based on cell deployment.

13. The computer program product of claim 11, wherein program code instructions for providing the cyclic-prefix and the cyclic-postfix include instructions for providing the cyclic-prefix and the cyclic-postfix such that a sum of lengths of the cyclic-prefix and the cyclic-postfix is fixed to a constant value based on system bandwidth configuration.

14. The computer program product of claim 11, wherein program code instructions for providing the cyclic-prefix and the cyclic-postfix include instructions for providing the cyclic-prefix and the cyclic-postfix to only selected subframes.

15. The computer program product of claim 11, wherein program code instructions for providing the cyclic-prefix and the cyclic-postfix include instructions for providing the cyclic-prefix and the cyclic-postfix such that a length of the cyclic-prefix is enabled to be different than a length of the cyclic-postfix.

16. A method comprising:
measuring timing differences between downlink signals received at a mobile terminal in connection with coordinated multi-point (CoMP) transmission from a serving cell and one or more coordinating cells; and
adjusting uplink transmission timing for signals to be transmitted from the mobile terminal based on the timing differences measured.

17. The method of claim 16, further comprising differentiating a source of each respective signal received at the mobile terminal in connection with CoMP transmission.

18. The method of claim 16, wherein differentiating the source comprises measuring transmissions corresponding to a downlink channel associated with timing synchronization or indicative of cell identity.

19. The method of claim 18, wherein differentiating the source comprises associating a physical cell identity of each signal measured from the downlink channel with a corresponding received signal.

20. An apparatus comprising a processor configured to:
measure timing differences between downlink signals received at a mobile terminal in connection with coordinated multi-point (CoMP) transmission from a serving cell and one or more coordinating cells; and
adjust uplink transmission timing for signals to be transmitted from the mobile terminal based on the timing differences measured.

21. The apparatus of claim 20, wherein the processor is further configured to differentiate a source of each respective signal received at the mobile terminal in connection with CoMP transmission.

22. The apparatus of claim 20, wherein the processor being configured to differentiate the source the processor being configured to measure transmissions corresponding to a downlink channel associated with timing synchronization or indicative of cell identity.

23. The apparatus of claim 22, wherein the processor being configured to differentiate the source the processor being configured to associate a physical cell identity of each signal measured from the downlink channel with a corresponding received signal.

24. A computer program product comprising at least one computer-readable storage medium having computer-executable program code instructions stored therein, the computer-executable program code instructions comprising:
program code instructions for measuring timing differences between downlink signals received at a mobile terminal in connection with coordinated multi-point (CoMP) transmission from a serving cell and one or more coordinating cells; and
program code instructions for adjusting uplink transmission timing for signals to be transmitted from the mobile terminal based on the timing differences measured.

25. The computer program product of claim 24, further comprising program code instructions for differentiating a source of each respective signal received at the mobile terminal in connection with CoMP transmission.

26. The computer program product of claim 24, wherein program code instructions for differentiating the source include instructions for measuring transmissions corresponding to a downlink channel associated with timing synchronization or indicative of cell identity.

27. The computer program product of claim 26, wherein program code instructions for differentiating the source include instructions for associating a physical cell identity of each signal measured from the downlink channel with a corresponding received signal.
